(19) United States
(12) Patent Application Publication
(10) Pub. No.: US 2025/0372785 A1
(43) Pub. Date: Dec. 4, 2025

(54) ENERGY STORAGE SYSTEM INCLUDING DEEP DRAWN TRAYS WITH INTEGRATED SUBMODULE SUPPORTS

(71) Applicant: Fluence Energy, LLC, Arlington, VA (US)

(72) Inventors: Jordan David Petrie, Neenah, WI (US); Kathryn Corine Streng Callahan, Golden, CO (US)

(73) Assignee: Fluence Energy, LLC, Arlington, VA (US)

(21) Appl. No.: 19/221,866

(22) Filed: May 29, 2025

Related U.S. Application Data
(60) Provisional application No. 63/654,586, filed on May 31, 2024.

(51) Int. Cl. H01M 50/242; H01M 10/613; H01M 10/6554; H01M 50/209

(52) U.S. Cl. CPC H01M 50/242; H01M 10/613; H01M 10/6554; H01M 50/209

(57) ABSTRACT

An energy storage enclosure includes a battery pack, a plurality of battery modules arranged within the battery pack, and a plurality of battery submodules arranged within each of the plurality of battery modules. Each of the plurality of submodules includes a tray, and a plurality of submodule cell stacks arranged within the tray. The tray includes a bottom portion adjacent to a bottom side of the plurality of submodule cell stacks and a wall portion extending upwardly from a perimeter of the bottom portion to a flange portion extending outwardly from the wall portion. A first cell expansion support is fixedly attached to an inside surface of the bottom portion of the tray. A second cell expansion support is fixedly attached to an inside surface of the bottom portion of the tray.

### CROSS REFERENCE TO RELATED APPLICATION

This application claims the benefit of, and right of priority to, U.S. Provisional Patent Application No. 63/654,586, filed May 31, 2024, and entitled “ENERGY STORAGE SYSTEM INCLUDING DEEP DRAWN TRAYS WITH INTEGRATED SUBMODULE SUPPORTS,” the contents of which are expressly incorporated by reference as if fully set herein.

### INTRODUCTION

The concepts described herein relate generally to energy storage systems, and more specifically, to modular energy storage systems including deep drawn trays with integrated submodule supports.

Modular energy storage systems include multiple individual energy storage enclosures interconnected to provide varied levels of storage capacity. Energy storage systems can be used to store additional power produced by an external power source during periods of reduced demand and provide additional power to external power sources during periods of increased demand.

Each individual energy storage enclosure includes multiple battery modules containing multiple submodules arranged within a tray. Each battery submodule includes multiple individual battery cell stacks arranged adjacent to one another, as well as end plates, which provide structural support within the battery submodule, and steel strapping, which provides additional structure to support cell expansion.

As such, it would be advantageous to provide a battery module with integrated structural support that increases the structural stiffness to the battery module, while decreasing component complexity and assembly time.

### SUMMARY

In view of the above discussion, it is useful to develop an energy storage system including battery modules having trays with integrated submodule or cell expansion supports that adds structural support to the battery module, while reducing component complexity, and assembly time.

The concepts disclosed herein relate to an energy storage system that includes battery modules having trays with integrated cell expansion supports fixedly attached to an inside surface of each tray. The integrated cell expansion supports provide structural support, in the form of structural stiffness, for the battery module, and for cell expansion.

An energy storage enclosure according to the present disclosure may include a battery pack, a plurality of battery modules arranged within the battery pack, and a plurality of battery submodules arranged within each of the plurality of battery modules.

Each of the plurality of battery modules may include a tray, and a plurality of submodule cell stacks arranged within the tray. The tray may include a bottom portion adjacent to a bottom side of the plurality of submodule cell stacks. The bottom portion may have a perimeter. A wall portion may extend upwardly from the perimeter of the bottom portion to a flange portion extending outwardly from the wall portion.

A first cell expansion support may be fixedly attached to an inside surface of the bottom portion of the tray, and a second cell expansion support may be fixedly attached to the inside surface of the bottom portion of the tray. The first cell expansion support may be attached adjacent to a first side of the plurality of submodule cell stacks, and the second cell expansion support may be attached adjacent to a second side of the plurality of submodule cell stacks.

Each of the first cell expansion support and the second cell expansion support may include a c-channel having a base portion, an upper flange portion, and a lower flange portion.

The lower flange portion of each c-channel may be attached via spot welding to the inside surface of the bottom portion of the tray.

An electronics/connection area may be defined between the second cell expansion support and an inside surface of the wall portion of the tray.

A cold plate may be arranged between the bottom portion of the tray and the plurality of submodule cell stacks.

The tray may include a one-piece stamped tray, which may be a deep drawn tray.

According to another aspect of the disclosure, a modular energy storage system may include at least two energy storage enclosures in communication with one another, and a power conversion module in communication with an external power source and the at least two energy storage enclosures.

Each of the at least two energy storage enclosures may include a battery pack, a plurality of battery modules arranged within the battery pack, and a plurality of battery submodules arranged within each of the plurality of battery modules.

Each of the plurality of battery modules may include a tray, a plurality of submodule cell stacks arranged within the tray.

The tray may include a bottom portion adjacent to a bottom side of the plurality of submodule cell stacks. The bottom portion may have a perimeter. A wall portion may extend upwardly from the perimeter of the bottom portion to a flange portion extending outwardly from the wall portion.

A first cell expansion support may be fixedly attached to an inside surface of the bottom portion of the tray, and a second cell expansion support may be fixedly attached to the inside surface of the bottom portion of the tray.

The first cell expansion support may be attached adjacent to a first side of the plurality of submodule cell stacks, and the second cell expansion support may be attached adjacent to a second side of the plurality of submodule cell stacks.

Each of the first cell expansion support and the second cell expansion support may include a c-channel having a base portion, an upper flange portion, and a lower flange portion.

The lower flange portion of each c-channel may be attached via spot welding to the inside surface of the bottom portion of the tray.

An electronics/connection area may be defined between the second cell expansion support and an inside surface of the wall portion of the tray.

A cold plate may be arranged between the bottom portion of the tray and the plurality of submodule cell stacks.

The tray may include a one-piece stamped tray, which may be a deep drawn tray.

According to another aspect of the disclosure, a battery module for an energy storage enclosure is also disclosed. The battery module may include a tray, and a plurality of submodule cell stacks arranged within the tray. The tray may include a bottom portion adjacent to a bottom side of the plurality of submodule cell stacks. The bottom portion may have a perimeter. A wall portion may extend upwardly from the perimeter of the bottom portion to a flange portion extending outwardly from the wall portion.

A first cell expansion support may be fixedly attached to an inside surface of the bottom portion of the tray, and a second cell expansion support may be fixedly attached to the inside surface of the bottom portion of the tray. The first cell expansion support may be attached adjacent to a first side of the plurality of submodule cell stacks, and the second cell expansion support may be attached adjacent to a second side of the plurality of submodule cell stacks.

Each of the first cell expansion support and the second cell expansion support may include a c-channel having a base portion, an upper flange portion, and a lower flange portion.

The lower flange portion of each c-channel may be attached via spot welding to the inside surface of the bottom portion of the tray.

An electronics/connection area may be defined between the second cell expansion support and an inside surface of the wall portion of the tray.

A cold plate may be arranged between the bottom portion of the tray and the plurality of submodule cell stacks.

The tray may include a one-piece stamped tray, which may be a deep drawn tray.

By providing a tray with integrated cell expansion supports, structural support, in the form of structural stiffness, for the battery module and for cell expansion is increased, while component complexity and assembly time is decreased.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 schematically illustrates an energy storage system including a plurality of energy storage enclosures, in accordance with the disclosure.

FIG. 2 schematically illustrates an energy storage enclosure including a battery pack, in accordance with the disclosure.

FIG. 3 schematically illustrates an exploded view of a battery module in accordance with one aspect of the disclosure.

FIG. 4 schematically illustrates a cross-sectional front view of a battery module including a tray, in accordance with one aspect of the disclosure.

FIG. 5 schematically illustrates a cross-sectional side view of a battery module including a tray, in accordance with one aspect of the disclosure.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

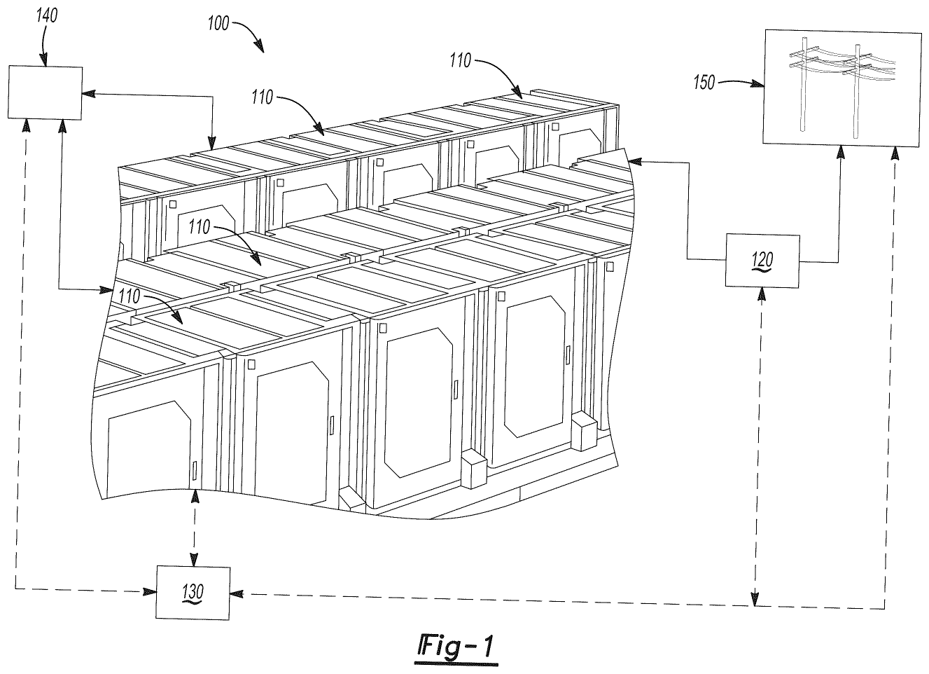

Referring to the drawings, wherein like reference numbers refer to the same or like components in the several Figures, FIG. 1 schematically illustrates an isometric view of an energy storage system 100 including a plurality of energy storage enclosures 110. The energy storage system 100 includes the plurality of energy storage enclosures 110, a power conversion module 120, a controller 130, an external cooling system 140, and an external power source 150.

The plurality of energy storage enclosures 110 are coupled to one another electrically, and collectively coupled to the power conversion module 120, the controller 130, the external cooling system 140, and the external power source 150. The plurality of energy storage enclosures 110, individually and collectively, are operable to store alternating current (AC) power delivered from the external power source 150 as direct current (DC) power, for example but not limited to when the demand for power from the external power source 150 is lower that the external power source 150 is operable to generate, and/or to provide DC power to the external power source 150, for example but not limited to, when the demand for power is higher than the external power source 150 is operable to generate. It should be appreciated that the plurality of energy storage enclosures 110 may be coupled to one another not only electrically, but also mechanically, and/or fluidly.

To facilitate the conversion of AC power to DC power and DC power to AC power, the power conversion module 120 is configured to standardize power input and output between the plurality of energy storage enclosures 110 and the external power source 150. The power conversion module 120 may include, for example but not limited to, a converter configured to convert AC power to DC power, and/or DC power to AC power.

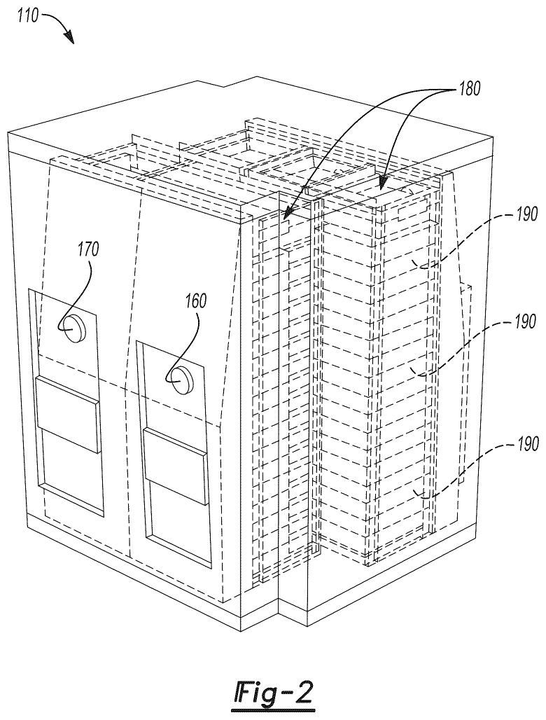

The external cooling system 140 is coupled to the plurality of energy storage enclosures 110, and the controller 130. The external cooling system is configured to provide coolant at a first temperature T₁ to the plurality of energy storage enclosures 110 through at least one input port 160 and receive coolant from the plurality of energy storage enclosures 110 at a second temperature T₂ from at least one output port 170 (FIG. 2), such that T₁ is lower than T₂.

The external cooling system 140 may include, for example but not limited to, a heat exchanging system having a pump, a condenser, a heat exchange, and a sump. It should be appreciated that the at least one input port 160 and the at least one output port 170 may include more than one input port 160 and/or one output port 170, and each of which may be arranged in one or more of the plurality of energy storage enclosures 110.

The external power source 150 is coupled to the plurality of energy storage enclosures 110. The external power source 150 is operable to provide AC power converted to DC power to the plurality of energy storage enclosures 110 to be stored as DC power, and to receive AC power converted from DC power from the plurality of energy storage enclosures 110, as discussed above.

The controller 130 is in communication with the plurality of energy storage enclosures 110, the power conversion module 120, the external cooling system 140, and the external power source 150, and is configured to control the aforementioned plurality of energy storage enclosures 110, the power conversion module 120, the external cooling system 140, and their communication with the external power source 150.

The term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated memory component(s) in the form of transitory and/or non-transitory memory component(s) and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that may be accessed by one or more processors to provide a described functionality. Input/output circuit(s) and devices include analog/digital inverters and related devices that monitor inputs from sensors, with such inputs monitored at a preset sampling frequency or in response to a triggering event. Software, firmware, programs, instructions, control routines, code, algorithms and similar terms mean controller-executable instruction sets including calibrations and look-up tables.

As schematically illustrated in FIG. 2, the energy storage enclosure 100 includes a battery pack 180, and a plurality of battery modules 190 arranged within the battery pack 180.

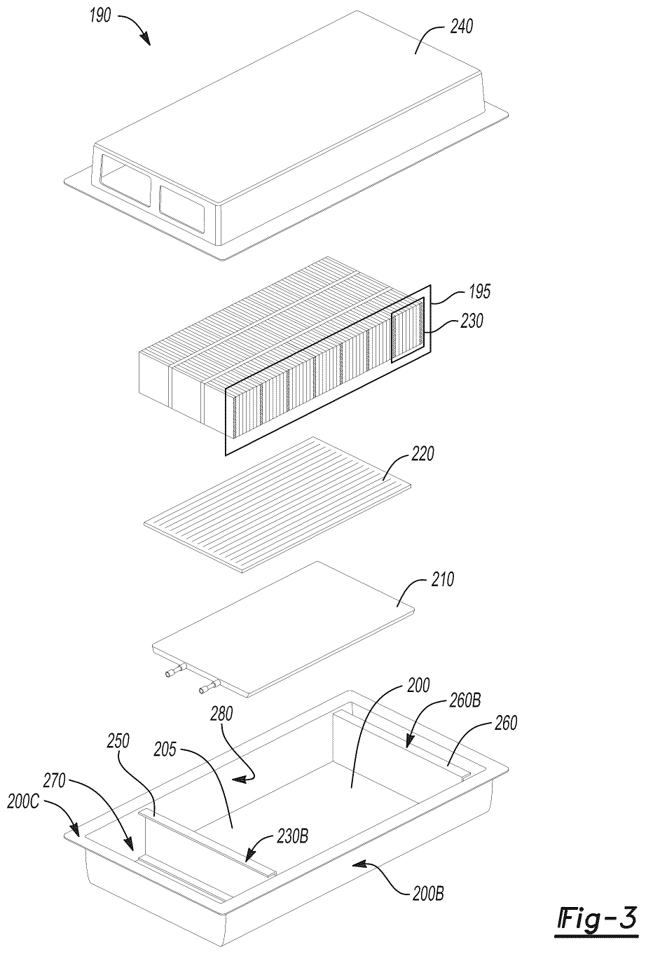

An exploded view of one of the plurality of battery modules 190 is schematically illustrated in FIG. 3. The battery module 190 includes a tray 200, a cold plate 210, a thermal interface layer 220, a plurality of battery submodules 195 including a plurality of submodule cell stacks 230 arranged adjacent to one another, and an enclosure 240.

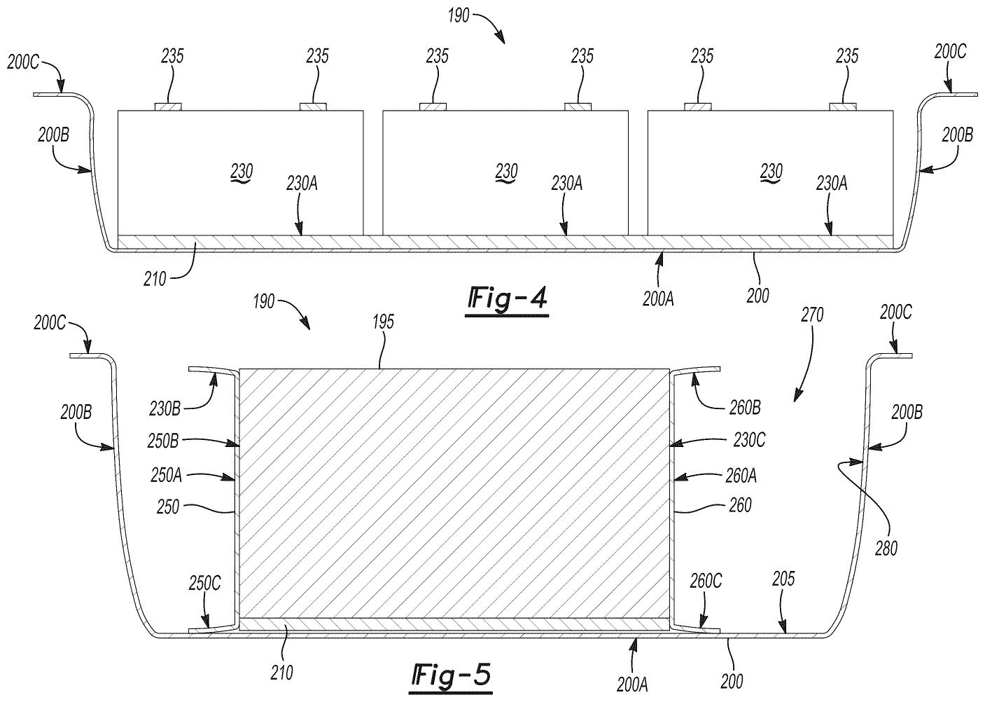

As schematically illustrated in FIG. 4, the tray 200 includes a bottom portion 200A adjacent to a bottom side 230A of the plurality of submodule cell stacks 230. The bottom portion 200A of the tray 200 has a perimeter P. A wall portion 200B extends upwardly from the perimeter P of the bottom portion 200A to a flange portion 200C extending outwardly from the wall portion 200B. The plurality of submodule cell stacks 230 include terminals 235.

As schematically illustrated in FIG. 5, a first cell expansion support 250 is fixedly attached to an inside surface 205 of the bottom portion 200A of the tray 200, and a second cell expansion support 260 is fixedly attached to the inside surface 205 of the bottom portion 200A of the tray 200. The first cell expansion support 250 is attached adjacent to a first side 230B of the plurality of submodule cell stacks 230, and the second cell expansion support 260 is attached adjacent to a second side 230C of the plurality of submodule cell stacks 230.

Each of the first cell expansion support 250 and the second cell expansion support 260 includes a c-channel having a base portion 250A, 260A, an upper flange portion 250B, 260B, and a lower flange portion 250C, 260C.

The lower flange portion 250C, 260C of each c-channel is attached via spot welding to the inside surface 205 of the bottom portion 200A of the tray 200. It should be appreciated that each c-channel may be attached to the bottom portion 200A via mechanical connection, for example but not limited to, bolts, rivets, tog-l-loc'd connection, or the like.

An electronics/connection area 270 is defined between the second cell expansion support 260 and an inside surface 280 of the wall portion 200B of the tray 200.

A cold plate 210 is arranged between the bottom portion 200A of the tray 200 and the plurality of submodule cell stacks 230.

The tray 200 includes a one-piece stamped tray, which may be a deep drawn tray.

According to another aspect of the disclosure, a modular energy storage system 100 is also disclosed. The modular energy storage system 100 includes at least two energy storage enclosures 110 coupled to one another, and a power conversion module 120 coupled to an external power source 150 and the at least two energy storage enclosures 110.

Each of the at least two energy storage enclosures 110 includes a battery pack 180, a plurality of battery modules 190 arranged within the battery pack 180, and a plurality of battery submodules 195 arranged within each of the plurality of battery modules 190.

Each of the plurality of battery modules 190 includes a tray 200, a plurality of submodule cell stacks 230 arranged within the tray 200.

The tray 200 includes a bottom portion 200A adjacent to a bottom side 230A of the plurality of submodule cell stacks 230. The bottom portion 200A of the tray 200 has perimeter P. A wall portion 200B extends upwardly from the perimeter P of the bottom portion 200A to a flange portion 200C extending outwardly from the wall portion 200B.

A first cell expansion support 250 is fixedly attached to an inside surface 205 of the bottom portion 200A of the tray 200, and a second cell expansion support 260 is fixedly attached to the inside surface 205 of the bottom portion 200A of the tray 200.

The first cell expansion support 250 is attached adjacent to a first side 230B of the plurality of submodule cell stacks 230, and the second cell expansion support 260 is attached adjacent to a second side 230C of the plurality of submodule cell stacks 230.

Each of the first cell expansion support 250 and the second cell expansion support 260 includes a c-channel having a base portion 250A, 260A, an upper flange portion 250B, 260B, and a lower flange portion 250C, 260C.

The lower flange portion 250C, 260C of each c-channel is attached via spot welding to the inside surface 205 of the bottom portion 200A of the tray 200. It should be appreciated that each c-channel may be attached to the bottom portion 200A via mechanical connection, for example but not limited to, bolts, rivets, tog-l-loc'd connection, or the like.

An electronics/connection area 270 is defined between the second cell expansion support 260 and an inside surface 280 of the wall portion 200B of the tray 200.

A cold plate 210 is arranged between the bottom portion 200A of the tray 200 and the plurality of submodule cell stacks 230.

The tray 200 includes a one-piece stamped tray, which may be a deep drawn tray.

According to another aspect of the disclosure, a battery module 190 for an energy storage system 100 is also disclosed. The battery module 190 includes a tray 200, a cold plate 210, a thermal interface layer 220, a plurality of battery submodules 195 including a plurality of submodule cell stacks 230 arranged adjacent to one another, and an enclosure 240.

The tray 200 includes a bottom portion 200A adjacent to a bottom side 230A of the plurality of submodule cell stacks 230. The bottom portion 200A of the tray 200 has a perimeter P (FIG. 4). A wall portion 200B extends upwardly from the perimeter P of the bottom portion 200A to a flange portion 200C extending outwardly from the wall portion 200B. The plurality of submodule cell stacks 230 include terminals 235.

A first cell expansion support 250 is fixedly attached to an inside surface 205 of the bottom portion 200A of the tray 200, and a second cell expansion support 260 is fixedly attached to the inside surface 205 of the bottom portion 200A of the tray 200 (FIG. 5). The first cell expansion support 250 is attached adjacent to a first side 230B of the plurality of submodule cell stacks 230, and the second cell expansion support 260 is attached adjacent to a second side 230C of the plurality of submodule cell stacks 230.

Each of the first cell expansion support 250 and the second cell expansion support 260 includes a c-channel having a base portion 250A, 260A, an upper flange portion 250B, 260B, and a lower flange portion 250C, 260C.

The lower flange portion 250C, 260C of each c-channel is attached via spot welding to the inside surface 205 of the bottom portion 200A of the tray 200. It should be appreciated that each c-channel may be attached to the bottom portion 200A via mechanical connection, for example but not limited to, bolts, rivets, tog-l-loc'd connection, or the like.

An electronics/connection area 270 is defined between the second cell expansion support 260 and an inside surface 280 of the wall portion 200B of the tray 200.

A cold plate 210 is arranged between the bottom portion 200A of the tray 200 and the plurality of submodule cell stacks 230.

The tray 200 includes a one-piece stamped tray, which may be a deep drawn tray.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. An energy storage enclosure comprising:
a battery pack;
a plurality of battery modules arranged within the battery pack;
a plurality of battery submodules arranged within each of the plurality of battery modules, wherein each of the plurality of battery modules includes:
a tray;
a plurality of submodule cell stacks arranged within the tray, wherein the tray includes:
a bottom portion adjacent to a bottom side of the plurality of submodule cell stacks, the bottom portion having a perimeter;
a wall portion extending upwardly from the perimeter of the bottom portion to a flange portion extending outwardly from the wall portion;
a first cell expansion support fixedly attached to an inside surface of the bottom portion of the tray; and
a second cell expansion support fixedly attached to the inside surface of the bottom portion of the tray, wherein the first cell expansion support is attached adjacent to a first side of the plurality of submodule cell stacks, and the second cell expansion support is attached adjacent to a second side of the plurality of submodule cell stacks.

2. The energy storage enclosure as recited in claim 1, wherein each of the first cell expansion support and the second cell expansion support includes a c-channel.

3. The energy storage enclosure as recited in claim 2, wherein each c-channel includes a base portion, an upper flange portion, and a lower flange portion, and wherein the lower flange portion of each c-channel is attached via spot welding to the inside surface of the bottom portion of the tray.

4. The energy storage enclosure as recited in claim 1, wherein an electronics/connection area is defined between the second cell expansion support and an inside surface of the wall portion of the tray.

5. The energy storage enclosure as recited in claim 1, including a cold plate arranged between the bottom portion of the tray and the plurality of submodule cell stacks.

6. The energy storage enclosure as recited in claim 1, wherein the tray includes a one-piece stamped tray.

7. A modular energy storage system comprising:
at least two energy storage enclosures coupled to one another;
a power conversion module coupled to an external power source and the at least two energy storage enclosures, wherein each of the at least two energy storage enclosures includes:
a battery pack;
a plurality of battery modules arranged within the battery pack; and
a plurality of battery submodules arranged within each of the plurality of battery modules, wherein each of the plurality of battery modules includes:
a tray;
a plurality of submodule cell stacks arranged within the tray, wherein the tray includes:
a bottom portion adjacent to a bottom side of the plurality of submodule cell stacks, the bottom portion having a perimeter;
a wall portion extending upwardly from the perimeter of the bottom portion to a flange portion extending outwardly from the wall portion;
a first cell expansion support fixedly attached to an inside surface of the bottom portion of the tray; and
a second cell expansion support fixedly attached to the inside surface of the bottom portion of the tray, wherein the first cell expansion support is attached adjacent to a first side of the plurality of submodule cell stacks, and the second cell expansion support is attached adjacent to a second side of the plurality of submodule cell stacks.

8. The modular energy storage system as recited in claim 7, wherein each of the first cell expansion support and the second cell expansion support includes a c-channel.

9. The modular energy storage system as recited in claim 8, wherein each c-channel includes a base portion, an upper flange portion, and a lower flange portion.

10. The modular energy storage system as recited in claim 9, wherein the lower flange portion of each c-channel is attached via spot welding to the inside surface of the bottom portion of the tray.

11. The modular energy storage system as recited in claim 7, wherein an electronics/connection area is defined between the second cell expansion support and an inside surface of the wall portion of the tray.

12. The modular energy storage system as recited in claim 7, including a cold plate arranged between the bottom portion of the tray and the plurality of submodule cell stacks.

13. The modular energy storage system as recited in claim 7, wherein the tray includes a one-piece stamped tray.

14. A battery module for an energy storage enclosure, the battery module comprising:
a plurality of battery submodules arranged within the battery module, wherein the battery module includes:
a tray;
a plurality of submodule cell stacks arranged within the tray, wherein the tray includes:
a bottom portion adjacent to a bottom side of the plurality of submodule cell stacks, the bottom portion having a perimeter;
a wall portion extending upwardly from the perimeter of the bottom portion to a flange portion extending outwardly from the wall portion;
a first cell expansion support fixedly attached to an inside surface of the bottom portion of the tray; and
a second cell expansion support fixedly attached to the inside surface of the bottom portion of the tray, wherein the first cell expansion support is attached adjacent to a first side of the plurality of submodule cell stacks, and the second cell expansion support is attached adjacent to a second side of the plurality of submodule cell stacks.

15. The battery module as recited in claim 14, wherein each of the first cell expansion support and the second cell expansion support includes a c-channel.

16. The battery module as recited in claim 15, wherein each c-channel includes a base portion, an upper flange portion, and a lower flange portion.

17. The battery module as recited in claim 16, wherein the lower flange portion of each c-channel is attached via spot welding to the inside surface of the bottom portion of the tray.

18. The battery module as recited in claim 14, wherein an electronics/connection area is defined between the second cell expansion support and an inside surface of the wall portion of the tray.

19. The battery module as recited in claim 14, including a cold plate arranged between the bottom portion of the tray and the plurality of submodule cell stacks.

20. The battery module as recited in claim 14, wherein the tray includes a one-piece stamped tray.
